(19) United States
(12) Patent Application Publication
(10) Pub. No.: US 2006/0219114 A1
(43) Pub. Date: Oct. 5, 2006

(54) SHEET TRANSPORT MECHANISM FOR IMAGE FORMING DEVICE

(75) Inventor: Takeshi IKETANI, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/278,146

(22) Filed: Mar. 31, 2006

(30) Foreign Application Priority Data
Mar. 31, 2005 (JP) 2005/102887

(51) Int. Cl. B41F 13/24

(52) U.S. Cl. 101/232

(57) ABSTRACT

A sheet transport mechanism is disclosed that has a simple structure and does not occupy a large amount of space. A return transport path includes a transport guide plate that guides and transports a sheet, a first U-shaped transport guide member having a curvature radius of approximately 60 mm or less, and a pair of transport rollers. The sheet conveying direction on the return transport path is changed by the first transport member, and the sheet is guided to a pair of sheet stopper rollers. Furthermore, a convex member is formed on the transport guide plate between the pair of transport rollers and the first U-shaped transport guide member in order to curve the sheet transported on the return transport path.

### CROSS-REFERENCE TO RELATED APPLICATIONS

This application claims priority to Japanese Patent Application No. 2005-102887. The entire disclosure of Japanese Patent Application No. 2005-102887 is hereby incorporated herein by reference.

### BACKGROUND OF THE INVENTION

1. Field of the Invention

The present invention relates to a sheet transport mechanism. More specifically, the present invention relates to a sheet transport mechanism in a sheet transport path in an image forming device.

2. Background Information

In an electrophotographic image forming device, components such as a charge unit, an exposure unit, a rotary developing unit, a transfer unit, and a cleaning unit are installed around a photosensitive drum that functions as a latent image bearing unit. In addition, a fixing unit is installed downstream of the photosensitive drum in the transfer media conveying path direction. In this type of image forming device, first, the surface of the photosensitive drum is uniformly charged by a charge unit. Then, the photosensitive drum is exposed by an exposure unit based on the image data, and thus an electrostatic latent image is formed on the surface of the photosensitive drum. The electrostatic latent image is developed by a rotary developing unit. In a full color image forming device, a cyan color developing agent, a magenta color developing agent, a yellow color developing agent, and a black color developing agent are stored individually within four sub rotary developing units, where toner images in each of these four colors are developed. In the transfer unit, the color image developed is transferred onto a transfer medium that is transported from a sheet feeding unit, and fixed by a fixing unit. Finally, the transfer medium with the color image formed thereon is discharged to a sheet discharge unit. In addition, the residuals of the developing agents remaining on the photosensitive drum are cleaned by a cleaning unit.

In this kind of image forming process, a transport path is formed between a sheet feeding unit and a sheet discharge unit in order to transport a sheet as a transfer medium. In addition, when image formation is performed on both surfaces of a sheet in an image forming device, a return transport path is provided in order to feed the sheet again in order to form another image on the other surface of the sheet after an image is formed on one surface thereof.

In recent years, miniaturization of an image forming device has been in demand with the increasing personal use of full color image forming devices. If the transport path of the sheet is straight, the size of the image forming device tends to be large. Accordingly, a method is disclosed in Japan Patent Application Publication JP-A-2001-260467 which miniaturizes an image forming device by installing a guide member that is curved in a circular arc shape as a portion of the sheet conveying path. In addition, a method of applying an organic coating material to a metal U-shaped guide that is installed on the circular arc shaped transport path is used for the purpose of reducing the radius of the circular arc of the circular arc transport path.

However, when the radius of the guide member curved in a circular arc shape is set to be small, a sheet that transitions from straight to curved in the transport path will strike the curved guide member, and a sound comprised of the sheet striking the guide member will be generated. In addition, the corners of the sheet will be easily bent, and paper jams will easily occur. Furthermore, when the organic coating material is applied to the metal U-shaped guide, the running cost of the image forming device will be increased. Moreover, when color image formation is performed, especially with double-sided printing, the amount of toner used in printing one side will be greater than the amount used in single side monochrome printing. Therefore, after the image is fixed on one surface of the sheet, there is a tendency for the sheet to become stiff. Therefore, the transport performance of the first U-shaped transport guide member will be degraded.

In view of the above, it will be apparent to those skilled in the art from this disclosure that there exists a need for an improved sheet transport mechanism. This invention addresses this need in the art as well as other needs, which will become apparent to those skilled in the art from this disclosure.

### SUMMARY OF THE INVENTION

It is therefore an object of the present invention to provide a sheet transport mechanism having a simple structure that does not occupy a great deal of space.

In accordance with a first aspect of the present invention, a sheet transport mechanism in a sheet conveying path in an image forming device is comprised of transport rollers, a first transport guide member, and a curve forming mechanism. Here, the transport rollers transport a sheet that is arranged in a direction perpendicular to the sheet conveying direction. The first transport guide member is installed downstream of the transport rollers in the sheet conveying direction in order to change the transport direction of the sheet. The curve forming mechanism forces the sheet to curve when it is transported to a position between the transport rollers and the first transport guide member.

The sheet is transported along the transport path in an image forming process. For example, in a circular arc transport path in which a first transport guide member is formed to change the sheet conveying direction, if the radius of the guide member curved in a circular arc shape is set to be small, the edge of the sheet will strike the first transport guide member when the sheet enters the circular arc transport path in which the transport guide member is formed from the straight transport path. On the other hand, when color image formation is performed, the sheet is stiffened after an image is fixed on one surface of the sheet. This is because a large amount of toner is used on one side during color image formation compared to monochrome image formation. Accordingly, transport performance is degraded in the circular arc transport path in which a first transport guide member is formed to change the sheet conveying direction. However, by applying the present invention to an image forming device, it is possible to reduce the stiffness of the sheet in the transport path by using a simple structure, and thus smooth transportation of the sheet can be realized. Furthermore, if stiffness of the sheet is reduced, it is possible to reduce the impact generated when the sheet enters the circular arc transport path in which a first transport guide member is formed from the straight transport path.

In accordance with a second aspect of the present invention, a sheet transport mechanism according to the first aspect of the present invention has a curve forming mechanism comprised of a transport guide plate that includes a curved member formed between the transport rollers and the first transport guide member in the sheet conveying path.

According to the second aspect of the present invention, it is possible to curve the sheet when it is transported to the position between the transport rollers and the first transport guide member in the sheet conveying path, by means of a simple structured transport guide plate having a curved member formed between the transport rollers and the first transport guide member. Therefore, even if the radius of the guide member curved in a circular arc shape is set to be small, it is still possible to reduce the impact generated when the sheet enters the circular arc transport path in which the first transport guide member is formed from the straight transport path. In addition, smooth transport of the sheet can be realized without having to apply an organic coating material, as done in a conventional metal U-shaped guide. Accordingly, it is possible to reduce the running cost of an image forming device compared to an image forming device where the coating material is applied.

In accordance with a third aspect of the present invention, a sheet transport mechanism according to the second aspect has a transport guide plate having a convex member curved in a direction perpendicular to the sheet conveying direction.

The transport rollers in the sheet conveying path comprise at least a pair of rollers, each roller having a separate axis and aligned in the axial direction. Therefore, when a sheet passes between these rollers, there may be a slight amount of curve in the direction parallel to the sheet conveying direction when a portion of the sheet is in contact with the rollers and a portion of the sheet is not in contact with the rollers. Thus, the sheet may be stiffened. This type of curve in the sheet may not be a problem when the sheet is linearly transported. However, it will be difficult for the sheet to pass through the U-shaped transport path because of this type of curve. According to the third aspect of the present invention, the transport guide plate includes a curved member located between the transport rollers and the first transport guide member in the sheet conveying path. This reduces the stiffness of the sheet when it is transported between the pair of the transport rollers and the U-shaped transport path, and thus smooth transport of the sheet can be realized.

In accordance with a fourth aspect of the present invention, the image forming device is a dual-sided image forming device in which images can be formed on both surfaces of a sheet. In addition, in the sheet transport mechanism, the sheet transport path is a return transport path used to re-feed the sheet in order to form an image on a second surface of the sheet after an image is formed on a first surface of the sheet.

The image forming device includes a return transport path used for changing the sheet conveying direction and re-feeding the sheet for the purpose of forming an image on the second surface of the sheet after an image is formed on the first surface of the sheet. In addition, transport rollers and a first transport guide member, both of which are located in the sheet conveying path, are installed in the return transport path. The radius of the first transport guide member is often set to be small in order to miniaturize the overall image forming device. In general, when the color image formation is performed, a large amount of toner is used for one sided printing. Accordingly, the sheet tends to stiffen after an image is formed on one side of the sheet. However, by applying the present invention to an image forming device, it is possible to reduce the stiffness of the sheet in the transport path with a simple mechanism, and thus smooth transportation of the sheet can be realized. Furthermore, according to the fourth aspect of the present invention, it is possible to reduce the impact generated when the sheet enters the circular arc transport path where the first transport member is formed from the straight transport path.

In accordance with a fifth aspect of the present invention, in the sheet transport mechanism according to the fourth aspect of the present invention, the transport rollers are a pair of return transport rollers formed in the return transport path. In addition, the first transport guide member is a circular arc guide that guides the sheet to a different sheet conveying direction. Furthermore, the curve forming mechanism is a transport guide plate located between the pair of the return transport rollers and a circular arc guide, and has a curved member.

In accordance with a sixth aspect of the present invention, in the sheet transport mechanism according to the fifth aspect of the present invention, the curved member of the transport guide plate is a convex member that is curved in a direction perpendicular to the sheet conveying direction.

In accordance with a seventh aspect of the present invention, in the sheet transport mechanism according to the sixth aspect of the present invention, the convex member is curved upward inside the first transport guide member.

According to the present invention, a curve forming mechanism is provided which transports the sheet so that the sheet is slightly curved when it is transported to a position between the transport rollers and the first transport guide member. Because of this mechanism, the stiffness of the sheet will be reduced when the sheet is transported through the conveying path. Thus, smooth transportation of the sheet can be realized. Furthermore, it is possible to reduce the impact generated when the sheet enters the circular arc transport path where the first transport guide member is formed from the straight transport path.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic structural view of a color printer according to one embodiment of the present invention.

FIG. 2 is a cross-section view of a return transport path

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

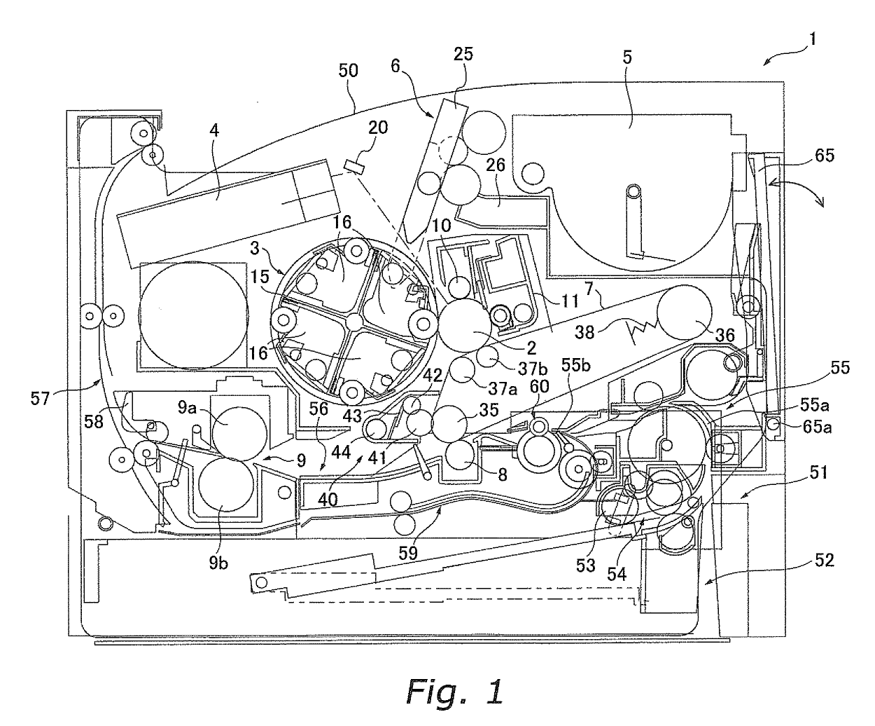

FIG. 1 shows a color printer 1 functioning as a color image forming device in accordance with one embodiment of the present invention. FIG. 1 is an overall structural view showing a layout of each of the components installed inside the color printer 1. Details of each of the components are not shown in the figure.

Overall Structure

The color printer 1 is connected to a device, such as a computer (not shown in the figure). It is capable of printing a color image on a print sheet based on image data received from the computer. The right side of the color printer 1 shown in FIG. 1 is the side on which an operator operates the color printer 1. The right side of the color printer 1 is hereinafter called “the front side” of the color printer 1. In contrast, the left side of the color printer 1 is hereinafter called “the rear side” of the color printer 1.

The color printer 1 comprises a photosensitive drum 2, a rotary developing unit 3, a laser unit 4, a toner storage unit 5, a toner supply unit 6, an intermediate transfer belt 7, a second transfer roller 8, and a fixing unit 9.

Photosensitive Drum

The photosensitive drum 2 is mounted substantially in the center of the color printer 1 and is able to rotate freely. An electrostatic latent image of the image data is formed on the surface of the photosensitive drum 2. The rotational shaft of the photosensitive drum 2 extends in a lateral direction when viewed from the front side of the device. In other words, it extends in a direction perpendicular to the face of the cross-sectional plane of the color printer 1 shown in FIG. 1. This direction is hereinafter called the “lateral direction.” A charge roller 10 that uniformly charges the surface of the photosensitive drum 2 is mounted on top of the photosensitive drum 2. In addition, a drum cleaning unit 11 that cleans the residual toner and attachments on the surface of the photosensitive drum 2 is mounted to the front side of the photosensitive drum 2.

Rotary Developing Unit

The rotary developing unit 3 develops the electrostatic latent image formed on the photosensitive drum 2 with various color toners. The rotary developing unit 3 is located adjacent to the photosensitive drum 2, with its center approximately aligned with the center of the photosensitive drum 2. The rotary developing unit 3 comprises a rotary frame 15, and four sub rotary developing units 16 that are supported by the rotary frame 15 and which contain four color toners. The rotary frame 15 is a cylindrical member rotatable around an axis parallel with the rotational shaft of the photosensitive drum 2. It is driven by a drive mechanism including a motor and gears (not shown in the figure).

In addition, the rotary frame 15 has four compartments that are formed by dividing the rotary frame 15 into quarters with partitions that are radially extending from the center of the rotational axis outward. Each of the compartments accommodates each of the sub rotary developing units 16, which contain four color toners of cyan, magenta, yellow, and black, respectively. The structure of each of the sub rotary developing units 16 is substantially the same. Each of the sub rotary developing units 16 comprises a developing roller that comes into contact with the photosensitive drum 2, a slide contact roller, and an agitation roller that agitates the toner.

Laser Unit

The laser unit 4 scans and exposes the photosensitive drum 2 based on the image data from the external device, such as a computer. It is located to the upper left (rear) of the photosensitive drum 2, and to the left of the rotational shaft of the rotary developing unit 3. More precisely, the front end (i.e., the laser emitting end) of the laser unit 4 is located above the rotational shaft of the rotary developing unit 3. The height of the rear end of the laser unit 4 is lower than the height of the upper surface of the rotary developing unit 3. The laser unit 4 is tilted up at the laser emitting end. The inner structure of the laser unit 4 is the same as the structure of a conventional laser unit, and comprises components such as a laser light source, a polygon mirror, and a motor for driving the polygon mirror. In addition, a reflective mirror 20 is located so that the laser light emitted from the laser unit 4 can strike the reflective mirror 20. Because of this, as shown by the dashed line in FIG. 1, the laser light emitted from the laser unit 4 is inflected by the reflective mirror 20 and travels over the front portion of the rotary development unit 3. Then, it is reflected onto the surface of the photosensitive drum 2.

Toner Storage Unit

The toner storage unit 5 stores toner to be supplied to each of the sub rotary developing units 16 located in the rotary developing unit 3. It is located above the photosensitive drum 2 to the right, and at the opposite end (i.e., the front side of the color printer 1) from the laser unit 4. The toner storage unit 5 comprises four toner containers 5a, 5b, 5c, and 5d (not shown in the figures) that are arranged in the lateral direction, and contain cyan, magenta, yellow, and black color toners, respectively. The toner storage unit 5 is detachable from the front side of the color printer 1.

Toner Supply Unit

The toner supply unit 6 supplies toner contained in the toner containers 5a, 5b, 5c, and 5d to the sub rotary developing units 16. It is located in the space between the laser unit 4 and the toner storage unit 5 above the photosensitive drum 2. Toner supply pipes 25 extend in the vertical direction and located so that its upper end tilts to the front side of the color printer 1 (i.e., its bottom end tilts to the rear side of the color printer 1). Also, each of the toner supply pipes 25 has a tapered tip that, when the pipe moves downward, the tip can enter into each of the corresponding sub rotary developing units 16 through a slit formed on each of the sub rotary developing units 16. In addition, a spiral component (not shown in the figure) that transports toner is rotatably installed inside each of the toner supply pipes 25.

Intermediate Transfer Belt

The intermediate transfer belt 7 is located below the photosensitive drum 2 and the toner storage unit 5. Each of the toner color images formed on the photosensitive drum 2 is sequentially transferred onto the surface of the intermediate transfer belt 7. The intermediate transfer belt 7 is looped over a driving roller 35 and a follower roller 36, located on the opposite ends. In addition, a pair of first transfer rollers 37a and 37b brings a portion of the transfer belt 7 into contact with the photosensitive drum 2.

Here, the above described intermediate transfer belt 7 and its surrounding components will be explained in detail. The driving roller 35 is located approximately below the contact portion of the photosensitive drum 2 and the rotary developing unit 3. The center of the driving roller 35 is positioned lower than the bottom end of the rotary developing unit 3. The driving roller 35 is driven by a driving unit including a motor and a gear (not shown in the figure). The follower roller 36 is located below the toner storage unit 5 toward the front side thereof, and is approximately the same height as the photosensitive drum 2. A spring 38 urges the follower roller 36 in the opposite direction of the driving roller 35. Thus a predetermined tension is created in the intermediate belt 7. In addition, the first transfer rollers 37a and 37b are located adjacent to each other, below the photosensitive drum 2. Thus, a portion in the transfer belt 7 comes into contact with the photosensitive drum 2.

A belt cleaning unit 40 cleans the transfer belt 7, and is located on the rear side of the driving roller 35 and below the rotary developing unit 3. The belt cleaning unit 40 comprises a fur brush 41 located opposite the driving roller 35 and which slides in contact with the transfer belt 7, a cleaning roller 42 located above the fur brush 41 and in contact with the fur brush 41, a blade 43 in which the tip thereof is in contact with the surface of the cleaning roller 42, and a recovery spiral 44 arranged below the blade 43.

In this cleaning unit 40, the residuals on the intermediate transfer belt 7 are scraped off by the fur brush 41, and collected by the cleaning roller 42. Then, the blade 43 scrapes off the residuals on the surface of the cleaning roller 42, and the residuals are collected by the recovery spiral 44 into a recovery unit (not shown in the figure).

Second Transfer Roller

A second transfer roller 8 transfers the image on the intermediate transfer belt 7 onto a print sheet conveyed to the second transfer roller 8. The second transfer roller 8 is located below the driving roller 35, and sandwiches the transfer belt 7 with the driving roller 35. In addition, bias voltage is applied to the second transfer roller 8 by an energizing unit (not shown in the figures) to transfer the image onto the print sheet.

Fixing Unit

A fixing unit 9 fixes the toner image on the print sheet by fusion. It is located to the lower left (rear) of the rotary developing unit 3 toward the rear end of the color printer 1. The fixing unit 9 comprises a heating roller 9a that has a built-in heater and a pressure roller 9b that is pressed against the heating roller 9a. The print sheet is held and transported between the heating roller 9a and the pressure roller 9b.

Discharge Portion

A discharge portion 50 is formed above the laser unit 4, the toner supply unit 6, and the toner storage unit 5 as the upper surface of the color printer 1. The discharge portion 50 functions as the portion which holds the print sheets when they are discharged after printing. The discharge portion 50 is comprised of a curved portion that curves gradually upward from the side of the laser unit 4 (i.e., from the rear side of the color printer 1) to the rear side of the toner storage unit 5 (i.e., toward the front side of the color printer 1), and a flat portion that is continuously formed to the curved portion above the toner storage unit 5.

Sheet Feeding Unit

A sheet feeding unit 51 is located at the bottom of the color printer 1. The sheet feeding unit 51 feeds print sheets that are stacked therein. The sheet feeding unit 51 has a feeding cassette 52 having a stacking plate on which the print sheets are stacked, a forward feeding roller 53 that forwards the print sheets out of the stacking plate, and a sheet feeding control mechanism 54 comprised of a pair of rollers that sends one print sheet at a time into the transport path. This sheet feeding control mechanism 54 prevents print sheets from being fed into the sheet conveying path more than one at a time. The sheet feeding cassette 52 can be pulled out of the color printer 1 from the front side.

Transport Mechanism

A transport mechanism is located between the sheet feeding unit 51 and the discharge portion 50, and transports print sheets from the sheet feeding unit 51 to the discharge portion 50. The transport mechanism comprises a first transport path 55 from the sheet feeding unit 51 to the second transfer roller 8, a second transport path 56 from the second transfer roller 8 to the fixing unit 9, and a third transport path 57 from the fixing unit 9 to the discharge portion 50. In addition, a branching claw 58 is located at the exit of the fixing unit 9. A return transport path 59 is located between this branching claw 58 and the middle of the first transport path 55 in order to return the print sheet back to the first transport path 55.

The first transport path 55 is comprised of a curved path 55a that conveys the print sheet sent from the feeding cassette 52 in an upward direction and in a reverse direction, and a straight path 55b that extends from the curved path 55a to the second transfer roller 8. These transport paths are composed of a guide plate and a pair of rollers for guiding and transporting the print sheet. Sensors are installed at predetermined places on these transport paths for detecting the location of the print sheet. In addition, a pair of sheet stopper rollers 60 is located on the straight path 55b in order to control the timing of transporting the print sheet.

The second transport path 56 is substantially linear. The second transport path 56 is comprised of a guide plate, and a pair of rollers for guiding and transporting the print sheet, as well as sensors on predetermined positions to detect the location of the print sheet.

The third transport path 57 has a vertical transport path downstream of the branching claw 58 in the sheet conveying direction. In other words, the print sheet is transported upward in a substantially vertical direction after passing the branching claw 58, and discharged onto the discharge portion 50. The third transport path 57 is also comprised of a guide plate and a pair of rollers for guiding and transporting the print sheet.

Return Transport Path

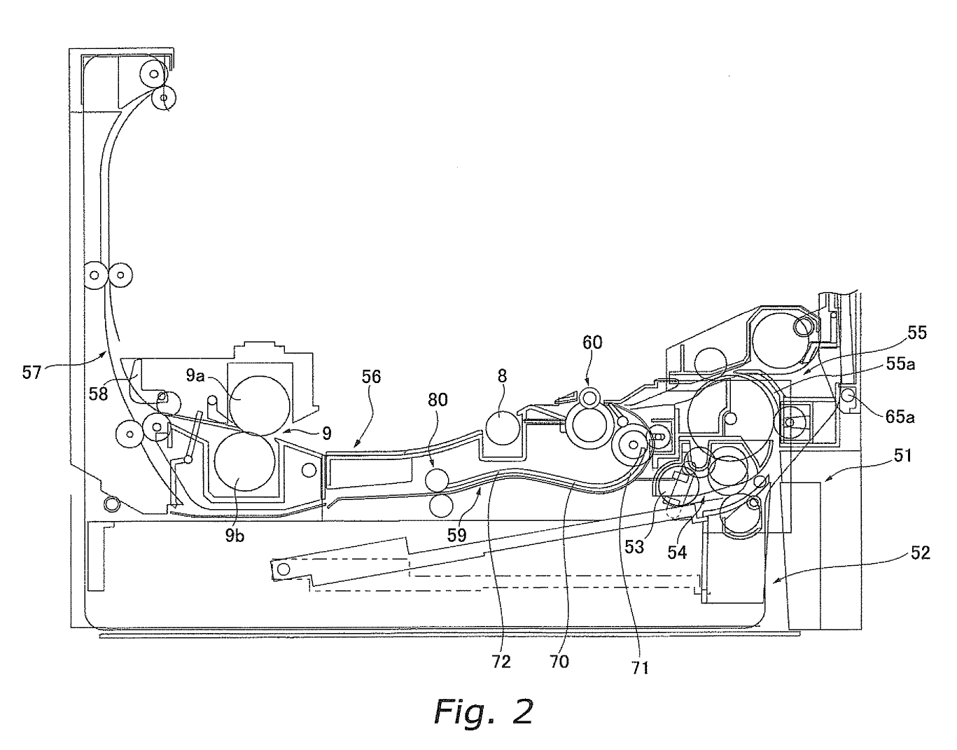

A return transport path 59 functioning as a sheet transport mechanism is shown in FIG. 2. The return transport path 59 is a transport path which branches off downward from the third transport path 57 at a place where the branching claw 58 is mounted. The return transport path 59 extends below the fixing unit 9, the second transport path 56, the second transfer roller 8, and the pair of the sheet stopper rollers 60, and extends upward to join the first transport path 55 at the upstream of the sheet stopper rollers 60 in the sheet conveying direction. In other words, the height of the location of the return transport path 59 is above the sheet feeding cassette 52, and below the straight path 55b of the first transport path 55 and the second transport path 56. In addition, the return transport path 59 returns the print sheet that passed through the fixing unit 9 to the upstream of the pair of the sheet stopper rollers 60 located upstream of the second transfer roller 8. The return transport path 59 also has the guide plate 70, a U-shaped first transport guide member 71, and the pair of transport rollers 80 for guiding and transporting sheets. Here, the first transport guide member 71 is formed in a U-shape and its radius is set to approximately 60 nm or less. The first transport guide member 71 changes the transport direction of the print sheet in the return transport path 59 and guides it to the pair of the sheet stopper rollers 60. In addition, the transport guide plate 70 has a convex member 72. The convex member 72 is located between the pair of transport rollers 80 and the U-shaped first transport guide member 71 in order to slightly curve the print sheet that is transported on the return transport path 59.

Sheet Feeding Tray

A sheet feeding tray 65 is located below the toner storage unit 5 and above the feeding cassette 52, and comprises the front side sidewall of the color printer 1. The lower end of the sheet feeding tray 65 is rotatably supported in the vicinity region of the curved path 55a of the first transport path 55. The sheet feeding tray 65 has a pivot 65a at the lower end. The sheet feeding tray can open and close freely. As shown in FIG. 2, when the sheet feeding tray 65 is pulled (i.e., opened), it pivots around the pivot 65a in the clockwise direction so that its upper end is inclined in the direction of the front side of the color printer 1, where the sheet feeding tray is opened to a predetermined position. Accordingly, when the sheet feeding tray 65 is opened, it is possible to put print sheets thereon and supply the print sheets into the curved path 55a of the first transport path 55.

Image Forming Operation

An image forming operation is hereinafter briefly explained. When the power of the color printer 1 is turned on, a variety of parameters and settings are initialized and defaults such as setting the temperature of the fixing unit is performed. Then, if image data containing a command to print the image data is input to the color printer 1 from a device (e.g., a computer) connected to this color printer 1, the following image forming operation is performed by the color printer 1. Note that the toner supply pipes 25 stay in the retracted position while the image forming operation is performed. Because of this, the laser light path is not blocked by any of the toner supply pipes 25.

First, the charge roller 10 charges the photosensitive drum 2. The laser unit 4 scans and exposes the photosensitive drum 2 based on the image data, and an electrostatic latent image is formed on the surface of the photosensitive drum 2. Then, the rotary developing unit 3 rotates to the position where the sub rotary developing unit 16 containing the corresponding color is positioned adjacent to the photosensitive drum 2. The electrostatic latent image on the photosensitive drum 2 is developed with this toner color. The developed image is transferred to the intermediate transfer belt 7. A full color image is formed on the intermediate transfer belt 7 by sequentially repeating the above described operation with respect to each of the colors. Note that the residual toner remaining on the photosensitive drum 2 is cleaned by the drum cleaning unit 11, and discharged to a waste toner container (not shown in the figure).

On the other hand, a print sheet is drawn out from the feeding cassette 52 by the forward feeding roller 53 and the feeding control mechanism 54 in the feeding unit 51. The print sheet is transported to the pair of the sheet stopper rollers 60 through the first transport path 55. Then, the print sheet is transported and guided from the pair of the sheet stopper rollers 60 to the second transport roller 8 in synchronization with the timing of the image formation on the intermediate transfer belt 7. A part of the second transfer roller 8 is in contact with the intermediate transfer belt 7, and the full color image formed on the surface of the intermediate transfer belt 7 is transferred to the print sheet by applying a transfer bias to the second transfer roller 8. Then, the print sheet is guided to the fixing unit 9 through the second transport path 56. The image is fixed onto the print sheet by the application of heat and pressure in the fixing unit 9.

For single-sided printing, the print sheet is guided to the third transport path 57 by the branching claw 58, and discharged onto the discharge portion 50. On the other hand, for a double-sided printing, after an image is fixed onto the print sheet in the fixing unit 9, the print sheet transported pass the branching claw 58 is transported in the reverse direction. It is guided to the return transport path 59 by the branching claw 58 and returned to the first transport path 55. The print sheet is temporarily held by the pair of the sheet stopper rollers 60. After the image to be formed on the other side of the print sheet is formed on the surface of the intermediate transfer belt 7 in the same way as the above described operation, the print sheet standing by at the pair of the sheet stopper rollers 60 is transported towards the second transfer roller 8 at the appropriate timing. Thus, the image is formed on the other surface of the print sheet in the same way as the above described operation, and the print sheet is guided to the third transport path 57 through the branching claw 58 and discharged onto the discharge portion 50.

In the return transport path 59, the convex member 72 forces the print sheet to curve when it is transported on the return transport path 59 between the pair of transport rollers 80 and the transport guide member 71. This softens the print sheet, and thus it is possible to transport the print sheet more smoothly, to reduce sudden impact, and better guide the sheet into the circular arc portion of the transport path 59 where the U-shaped first transport guide member 71 is formed from the straight path on a part of the transport path 59. Then, the transport direction of the print sheet is changed by the transport guide member 71, and guided to the pair of the sheet stopper rollers 60.

According to the present invention, when the print sheet is transported on a portion of the return transport path 59 between the pair of the transport rollers 80 and the first transport guide member 71, the print sheet is slightly curved by the convex member 72 on the return transport path 59. Therefore, it is possible to transport the print sheet more smoothly, to reduce sudden impact, and better guide the sheet into the circular transport path where the first transport guide member 72 with a radius of approximately 60 mm or less is formed. In addition, smooth transport of the print sheet can be realized without applying organic coating material, as with a conventional metal U-shaped guide. Because of this, it is possible to reduce the running cost of the color printer 1 in accordance with the present invention, compared to a conventional printer to which the coating material is applied.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A sheet transport mechanism for an image forming device, comprising:
a plurality of transport rollers that are configured to transport a sheet;
a first transport guide member arranged downstream of the plurality of transport rollers in a sheet conveying direction, the first transport guide member configured to guide the sheet so as to change the sheet conveying direction thereof; and
a curve forming mechanism that curves the sheet while transporting the sheet between the plurality of transport rollers and the first transport guide member.

2. The sheet transport mechanism according to claim 1, wherein the curve forming mechanism is comprised of a transport guide plate having a curved member formed between the plurality of transport rollers and the first transport guide member.

3. The sheet transport mechanism according to claim 2, wherein the curved member of the transport guide plate is a convex member that curves upward in the direction perpendicular to the transport direction of the sheet.

4. The sheet transport mechanism according to claim 1, wherein the sheet conveying path is a return transport path that is configured to re-feed the sheet in order to form an image on the second surface of the sheet after an image is formed on the first surface of the sheet.

5. The sheet transport mechanism according to claim 4,
wherein the plurality of transport rollers is a pair of return transport rollers arranged in the return transport path;
the first transport guide member is a circular arc guide configured to guide the sheet so as to change the transport direction of the sheet; and
the curve forming mechanism is arranged between the pair of return transport rollers and the circular arc guide, and comprised of a transport guide plate that has a curved member.

6. The sheet transport mechanism according to claim 5, wherein the curved member of the transport guide plate is a convex member that curves upward in the direction perpendicular to the transport direction of the sheet.

7. The sheet transport mechanism according to claim 6, wherein the convex member is curved upward inside the first transport guide member.
